(19) United States
(12) Patent Application Publication
(10) Pub. No.: US 2005/0192840 A1
(43) Pub. Date: Sep. 1, 2005

(54) Device for providing medical consultation services

(75) Inventors: Georg Gortler, Baiersdorf (DE); Rainer Kuth, Herzogenaurach (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/064,743

(22) Filed: Feb. 24, 2005

(30) Foreign Application Priority Data
Feb. 27, 2004 (DE) 10 2004 009 659.7

(51) Int. Cl. G06F 17/60

(52) U.S. Cl. 705/2; 705/32

(57) ABSTRACT

Device for provision of medical consultancy services, in which experts, especially radiological experts of clinics or universities for example, provide practical assistance to less specialized system operators such as doctors, MTAs or such like for optimum operation of medical examination or treatment devices, with both an expert's computer (10) as well as the medical system operator's device (5), which are preferably linked to each other via an Internet connection, being equipped with “remote service software” (7) which makes it possible for the devices to be operated remotely and with the system operator and the expert being connected to one another via a proxy server (11) of a service provider who both guarantees data protection and also coordinates billing for the consultancy services provided.

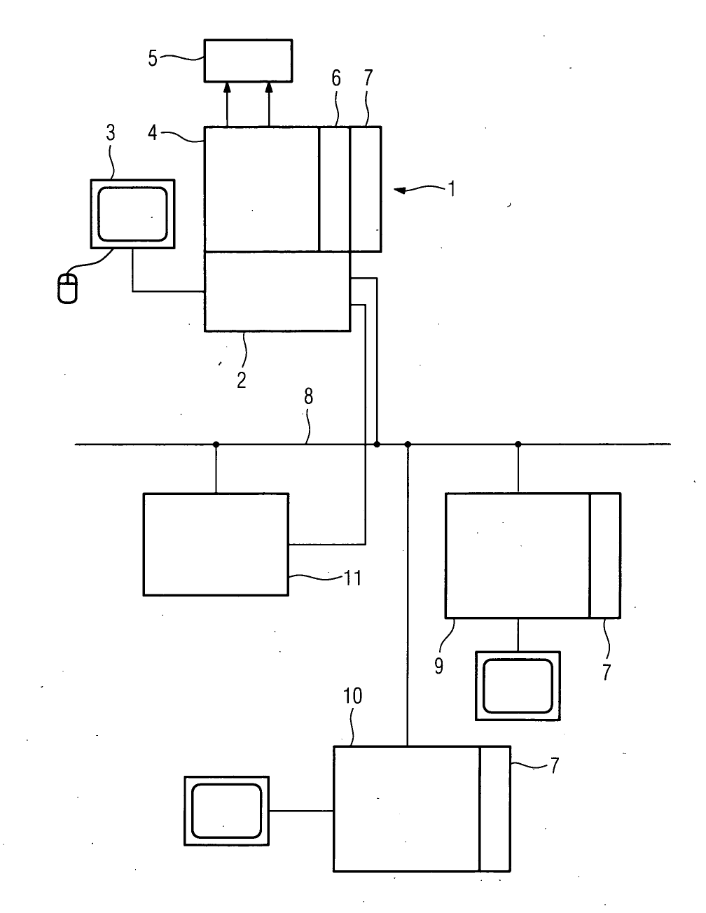

### CROSS REFERENCE TO RELATED APPLICATIONS

This application claims priority to the German application No. 10 2004 009 659.7, filed Feb. 27, 2004 which is incorporated by reference herein in its entirety.

### FIELD OF INVENTION

The invention relates to a device for provision of medical consultancy services in which experts, especially radiological experts, of clinics or universities for example, offer less specialized medical system users such as doctors, MTAs or similar practical assistance for optimum operation of medical examination or treatment equipment.

### BACKGROUND OF INVENTION

Sophisticated medical-diagnostic methods demand a high level of know-how from the operator of the system and from the doctor evaluating the images. New methods are constantly being developed and current methods developed. Frequently radiological institutes as well as general X-ray practitioners or also practical doctors with the corresponding diagnostics devices have to deal with extremely rare diseases, for the analysis of which specialized knowledge is required, said specialized knowledge not being able, for practical and cost reasons, to be held wherever it is required. On the other hand specialized experts, especially in university clinics, often encounter the problem that although their expertise is very frequently called on, it is difficult for them to provide concrete operating assistance to the doctor making the inquiry and also that billing for the consultancy services runs into difficulties.

### SUMMARY OF INVENTION

An object of the invention is to provide a device for provision of medical consultancy services which creates a fair balance between a system operator asking for the advice and the expert providing the advice.

This object is achieved by the claims.

This type of “remote service software” has previously been provided to allow the manufacturer of a medical device to undertake remote monitoring and where necessary also remote operation of the device at the premises of the operator of the system, this mostly being in general practitioners' surgeries, especially if the operator of the device is complaining about device failures or faults and the repair or correct setting is to be undertaken as quickly as possible by means of this type of remote operation.

In accordance with the invention this “remote service software” is now utilized by also equipping the computer of an expert providing consultancy services, of a university clinic for example, with this very same “remote service software” so that the expert is not obliged to make a verbal or written suggestion to the operator seeking the assistance as to how the device should best be set but that they are able to make these settings directly themselves, which not only saves a great deal of time but is naturally very much safer, since merely specifying what is to be done would in many cases not be at all sufficient with the complex devices which represent today's medical examination systems. In this connection the linking of the system operator and expert via a proxy server of a service provider is decisive for the success of the system, since this is the only way to guarantee a fair balance of interests, not to mention an effective settlement of payment.

The “remote service software” here is preferably assigned to the system operator's central operating computer for different medical devices, so that such software is not needed for each device.

This payment for consultancy services can either be coordinated by the system operator maintaining a credit account with the service provider, or also by the service provider providing the system operator with a limited credit framework and settling payments with the system operator by invoices, direct debiting or such like.

In addition it is of course also possible to provide other types of billing such as a pay-per-use method for example.

### BRIEF DESCRIPTION OF THE DRAWING

Further advantages, features and details of the invention are provided by the description of an exemplary embodiment below as well as by reference to the drawing which shows a schematic plan of an inventive device.

### DETAILED DESCRIPTION OF INVENTION

The number 1 indicates the device of the medical system operator, for example of a doctor, specifically of a general radiological practitioner, who has a computer 2 with screen 3, which via a corresponding system 4, for example the known system Syngo, can operate a medical device, for example a magnetic resonance scanner 5. As well as the service unit 6, this medical operating system at the doctor is equipped with the “remote service software” 7 assigned to the service unit 6, through which, usually over an Internet connection, indicated by the dashed line 8, testing and maintenance can be performed on the medical device 5 from a service terminal 9 of the device manufacturer.

In accordance with the invention provision is now made for the computer 10 of a specialized expert, for example in a university clinic, to also be provided with this “remote service software” 7 like the service terminal at the manufacturer and like the service part at the doctor's, so that the expert too, to provide medical consultancy services, can intervene directly into the operating controls of the medical device 5 at the doctor's, that is the system operator of this device 5. The expert's computer 10 and the system operator's computer 2 are not connected directly here, but are connected via an Internet connection to the proxy server 11 of a service provider, who provides both the data protection and in addition coordinates the billing of the services provided.

1-6. (canceled)

7. A device for providing a medical consultation service, the consultation service including providing practical assistance to a medical system operator by a medical expert, the device comprising:
a medical system for examining or treating a patient;
a computer assigned to the expert, the medical system and the computer equipped with a remote service software program enabling the medical system and the computer to be operated remotely; and
a proxy server assigned to a communication service provider for establishing communication between the expert and the medical system operator, wherein the proxy server is configured to provide data protection of the communication and to provide a billing service with respect to the medical consultation.

8. The device according to claim 7, wherein the medical expert is a radiologist.

9. The device according to claim 8, wherein the radiologist is located at a hospital or a university when the communication is established.

10. The device according to claim 7, wherein the medical system operator is a Medical Doctor or a Physician Assistant.

11. The device according to claim 7, wherein the computer and the medical system are configured to communicate via the Internet.

12. The device according to claim 7, further comprising a centralized operating computer installed at the medical system operator's site for controlling and operating a plurality of medical examination and/or treatment devices including the medical system, wherein the centralized operating computer includes the remote service software program.

13. The device according to claim 7, wherein the system operator maintains an account in credit with the service provider.

14. The device according to claim 7, wherein the service provider provides the system operator with a credit line and bills the system operator by invoicing or debiting.

15. The device according to claim 7, wherein the consultation service is billed to the system operator using a pay-per-use method installed as a billing software program on the medical system.

16. The device according to claim 7, wherein the medical system is configured to inhibit operating the medical system by the medical expert's computer.

17. The device according to claim 7, further comprising a control unit for inhibiting operating the medical system by the medical expert's computer.
